(19) United States
(12) Patent Application Publication
(10) Pub. No.: US 2016/0300069 A1
(43) Pub. Date: Oct. 13, 2016

(54) DATA SANITIZATION

(71) Applicant: HEWLETT-PACKARD DEVELOPMENT COMPANY, L.P., Houston, TX (US)

(72) Inventors: Boogarapu Anil, (US); Narayanan Ananthakrishnan Nellayi, Bangalore Karnataka (IN); Sarkar Shyamalends, Bangalore Karnataka (IN); Reddy N, Venkata Subba, Bangalore Karnataka (IN)

(21) Appl. No.: 15/038,584

(22) PCT Filed: Dec. 4, 2013
(86) PCT No.: PCT/US13/73204

§ 371 Date: May 23, 2016

(51) Int. Cl. G06F 21/62; G06F 17/30

(52) U.S. Cl. CPC G06F 21/62; G06F 17/30303; G06F 2221/2143

(57) ABSTRACT

Data sanitization comprises tracking at least one block being freed from a file when an action is performed on the file to remove data. Further, it is identified whether a sanitization attribute is associated with the file or not. The sanitization attribute includes a descriptor that indicates a sanitization process selected by a user. Based on the identification, it is determined whether the action is completely performed on the file or not. Thereafter, based on the determination, the at least one block is sanitized based on the sanitization process indicated in the sanitization attribute.

### BACKGROUND

The amount of data being created and stored by enterprises and for personal use is increasing at a phenomenal rate. Further, a large amount of data stored in storage devices is routinely deleted and overwritten. This data, however, may be stored for extended periods for various reasons, such as for later reference, auditing purposes, and to comply with various legal regulations. However, once the utility of the data is over, the data is typically deleted from the storage device. In order to make the data unrecoverable, in accordance with data security and privacy regulations, data sanitization is applied. Data sanitization is generally understood as the process of deliberately, permanently, and irreversibly removing the data stored on a storage device. After sanitization, the storage device typically has no usable residual data and the erased data is unrecoverable.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1A illustrates components of a data sanitization system, according to an example of the present subject matter.

FIG. 1B illustrates a network implementation of the data sanitization system, according to another example of the present subject matter.

FIG. 2A illustrates a method for sanitizing data, according to an example of the present subject matter.

FIGS. 2B and 2C illustrate methods for sanitizing data, according to other examples of the present subject matter.

FIG. 3 illustrates a computer readable medium storing instructions for sanitizing data, according to an example of the present subject matter.

### DETAILED DESCRIPTION

Data security and privacy related concerns have increased with advancements in technology. To secure data, the data is typically deleted from the storage systems once the utility of the data is over or after an allowable data retention period has lapsed. As may be known, the data retention period may be defined by business policies, legal regulations, or user preferences. Present day storage devices and file systems, however, may not completely erase the data and as a result the deleted data may be recovered by applying advanced data retrieval techniques.

Typically, data is stored in a storage device through a file system. A file system may be understood as a way of organizing data on the storage device. For example, the file system can facilitate in controlling how the data is stored and retrieved from the storage device. Further, a storage device includes many data storage units known as “blocks”. When a file is stored in the storage device, data is written to the blocks. Further, each file is associated with a pointer that points to the blocks storing the data. In addition, each file is associated with an index node (inode). The inode includes metadata about each file of a file system. The metadata may include, inode number, attributes, number of blocks, file size, file type, and the like. As may be understood, the inode does not store content of the file.

When data is removed from a file, typical file deletion processes remove the pointer associated with the file, but the data remains intact in the blocks until the data is overwritten. Further, many a times, the file system may internally re-structure data in the blocks. For example, during tiering operation, the file system may dynamically change the file's physical location within the storage device without impacting a logical structure of the file. As the data is migrated from one block of the storage device to another, the pointers may point to the new blocks and the earlier blocks may be shown as empty. Blocks from where the data is either deleted or moved to a new location, may hereinafter be referred to as freed blocks. The data, however, may be recoverable from the freed blocks until the data is overwritten by new data. Even after a low-level formatting of the storage device, the removed data may be recoverable. In certain situations, such as when the data includes confidential information, allowing the data to remain recoverable after it has been deleted may be undesirable.

To make the data unrecoverable from the freed blocks, for example after deletion or migration, data sanitization is applied. Data sanitization includes making data unrecoverable by permanently removing the data stored on a storage device. Sanitization processes typically involve executing a software application that completely erases the data from the storage device, for example, by overwriting the data multiple times. Present day sanitization processes facilitate in sanitizing an entire storage device managed by a file system and are ineffective when the data comes from a common storage pool that caters to multiple network file systems (NFS). For example, when multiple users are accessing data from network attached storage (NAS) systems, sanitization of the data blocks may not happen. The NAS systems are storage devices that can be accessed over the network and enable multiple users to share the same storage space simultaneously.

Further, the present day sanitization processes are based on user input, i.e., to sanitize any storage device, the user may have to provide explicit instructions or commands. For example, one command may be used to securely delete files. Another command may be used for overwriting a specified file repeatedly, in order to make it harder to recover the data. Using such functions may be inconvenient as the user may forget to sanitize the freed blocks, thereby posing a threat to security of the data stored earlier on those blocks. In addition, these commands sanitize data after deletion of data and are unable to handle sanitization for migration operations. As described above, after tiering operations, when data is moved from one location of the storage device to another, when these commands are applied, these commands delete the files from a current location of the storage device and do not sanitize the freed blocks from where the data has migrated.

Further, there may be instances where the user may wish to use a sanitization process of their own choice to sanitize blocks of the storage device, however, the present day sanitization processes perform sanitization based on pre-defined patterns. A sanitization process may be understood as a data destruction program that overwrites the data on a storage device, such as a hard disk drive. In addition, during sanitization operations, normal operations of the file system may get affected as the present day techniques do not provide a way of prioritizing the functions to be performed in the storage device based on user preferences.

In an embodiment of the present subject matter, a system and a method for sanitizing data is disclosed. The present subject matter provides a data sanitization system for securely erasing data in a storage device. The data sanitization system employs a journaling file system that maintains a log, also referred to as a journal, which includes a list of actions performed by the file system. An action may be understood to include a sequence of steps that can be treated as a single operation. For example, to create a new file, the steps may include modifying several meta-data structures, such as i-nodes and directory entries. Before the file system makes those changes, the file system creates an action in the log, that includes a list of what all steps the file system is about to do. Once all the steps associated with the action are completed on the storage device, the action is considered as completed.

In an implementation, the data sanitization system allows associating a sanitization attribute, such as a SecErase attribute, with a file. The sanitization attribute may indicate that when any block gets freed from the file, the freed block has to be sanitized. The sanitization attribute may also include a descriptor that indicates a sanitization process selected by a user. The sanitization attribute may be associated with the file either under user's control or automatically based on pre-defined rules, for example, when a data retention period for the file elapses. In an implementation, the sanitization attribute may be set at any level of hierarchy in the file system. Once the sanitization attribute is set, it may be automatically inherited in the hierarchy. Further, the sanitization attribute may, upon detecting removal of data from a block of the file, trigger sanitization of the freed block. The removal of the data from the block may be initiated by a user action, such as by operations like remove (rm), truncation (trunc), and defragmentation (defrag). Alternatively, the removal of the data from the block may be initiated by operations, such as tiering, of the file system.

In operation, when an action is performed on a file, a trigger is generated to track the freed blocks of the file. The action may be one of a file deletion, file truncation, file migration, and the like. Upon receiving the trigger, the data sanitization system may check whether all references to the file are closed or not. If any user is accessing the file, the data sanitization system may wait for the user to close the file, before proceeding with the action on the file. Once all the references to the file are closed, the data sanitization system may track the freed blocks of the file. Accordingly, the data sanitization system may generate a list, hereinafter referred to as a sanitization list, that includes a list of inodes of the files that are either deleted or modified. The inodes in turn may track the freed blocks of the file. In an implementation, when the action is file removal, the inode for that file may be added in the sanitization list. As mentioned above, the inode includes information about the blocks of the file. In case the action is truncating or migrating a file, the data sanitization system may assign a plurality of pseudo-inodes to track those blocks of the file that got truncated or migrated. The pseudo-inodes include information about the blocks that got truncated or migrated. The pseudo-inodes may start tracking blocks, as soon as the blocks are freed due to actions, such as migration, tiering, and truncation.

Once the sanitization list is generated, the data sanitization system may determine whether the sanitization attribute is associated with the file or not. If the sanitization attribute is not set for the file, a normal file deletion operation may be initiated. In case the sanitization attribute is set for the file, the data sanitization system may identify a sanitization process as may be provided in the sanitization attribute. The data sanitization system thereby facilitates performing sanitization on user selected files or directories using any sanitization process that the user may select.

In an implementation, a plurality of sanitization processes may be pre-defined in the data sanitization system and the user may select one of the plurality of pre-defined sanitization processes for sanitizing the file. The user may select the sanitization process at the time of setting the sanitization attribute with the file. Accordingly, the sanitization attribute may be associated with a descriptor that indicates the sanitization process selected by the user. In another implementation, the data sanitization system allows the user to provide a new sanitization process. Thereby, the data sanitization system enables the users, especially in a multi-tenant environment, to adopt any sanitization process for performing sanitization operations. Further, the data sanitization system may include application programming interfaces (APIs) for facilitating the user to plug any sanitization process to the file system.

Upon identifying the sanitization process to be used, the data sanitization system may determine whether or not the action on the file is completed or not. For example, if the action is removal of a file, the data sanitization system may determine whether the file removal action is committed to the storage device. If the file removal action is not committed to the storage device, the data sanitization system may wait for the file removal action to get committed to the storage device. As mentioned above, the data sanitization system maintains a log or journal in a memory thereof until the action is completed on the storage device. The data sanitization system may, upon determining completion of the file removal action to the storage device, determine if the user wants to bypass the file system or would like to go through the file system for sanitizing the freed blocks.

In an implementation, in case the user bypasses the file system, the data sanitization system may obtain a block map of the physical location of the file. The block map may then be stored in a buffer of the data sanitization system. Based on the block map, the sanitization process, as indicated by the sanitization attribute, is executed on the freed blocks. In case, the user intends to use the file system for sanitizing the file, an inode is obtained from the sanitization list. Thereafter, a block map identifying logical structure of the file is obtained and stored in the buffer. Based on the logical block map, the data sanitization system may identify the inode listed in the sanitization list for being sanitized and share the inode with user space for running the sanitization process of choice.

In an implementation, the data sanitization system may crash during the file removal action. In such cases, during recovery, the data sanitization system may retrieve the log stored in the memory. Upon recovery, the data sanitization system may identify what the latest entry was in the log. If the latest entry indicated completion of the file removal action to the storage device, the data sanitization system may continue with the sanitization of the freed blocks. In case the latest entry in the log does not indicate completion of the action to the storage device, the data sanitization system may roll back all steps that may have been performed in the file removal action, before crashing of the data sanitization system. In such cases, a user may have to provide a file removal command again.

In another implementation, in order to provide flexibility, the data sanitization system may enable the users to control bandwidth consumption during sanitization operations and other file system operations. In this respect, the data sanitization system may facilitate the users to indicate preferences with respect to prioritizing the sanitization and other file system operations, if performed simultaneously on the storage device. For example, the user may indicate that a sanitization process is to be given priority over other file system operations, such as data transfer, when occurring simultaneously.

Accordingly, the data sanitization system employs a pluggable, flexible, and extensible framework that enables the users to selectively sanitize freed blocks of a file instead of sanitizing an entire storage device. Further, the data sanitization system may employ a journaling file system to maintain a log of various steps involved in an action, such as a file removal action, for completing sanitization in an efficient manner without loss of data. Furthermore, the sanitization process may be selected by the user from a plurality of pre-defined sanitization processes. Alternatively, the users may employ their own sanitization process to sanitize the freed blocks. The data sanitization system also facilitates the users to control bandwidth consumption of the storage device when sanitization and other file system operations are occurring simultaneously.

The various systems and the methods are further described in conjunction with the following figures. It should be noted that the description and figures merely illustrate the principles of the present subject matter. Further, various arrangements may be devised that, although not explicitly described or shown herein, embody the principles of the present subject matter and are included within its scope.

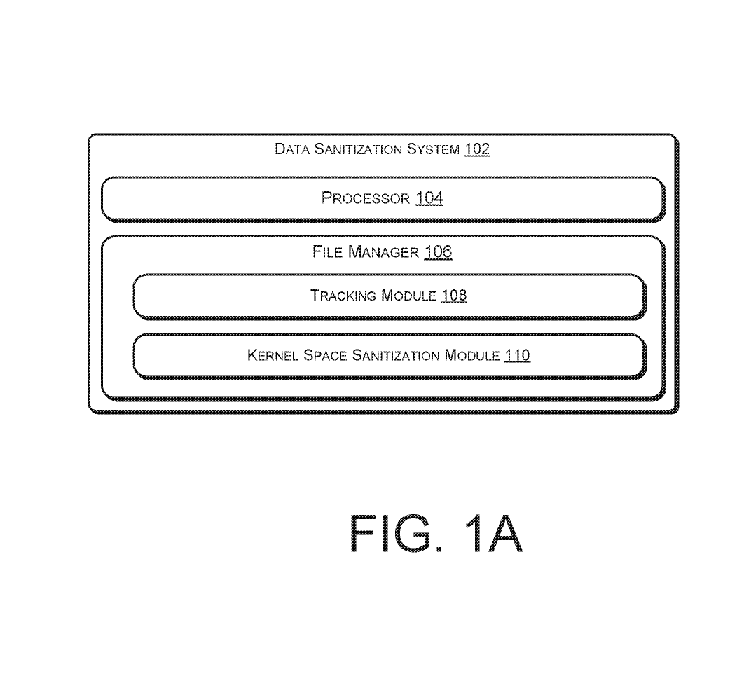

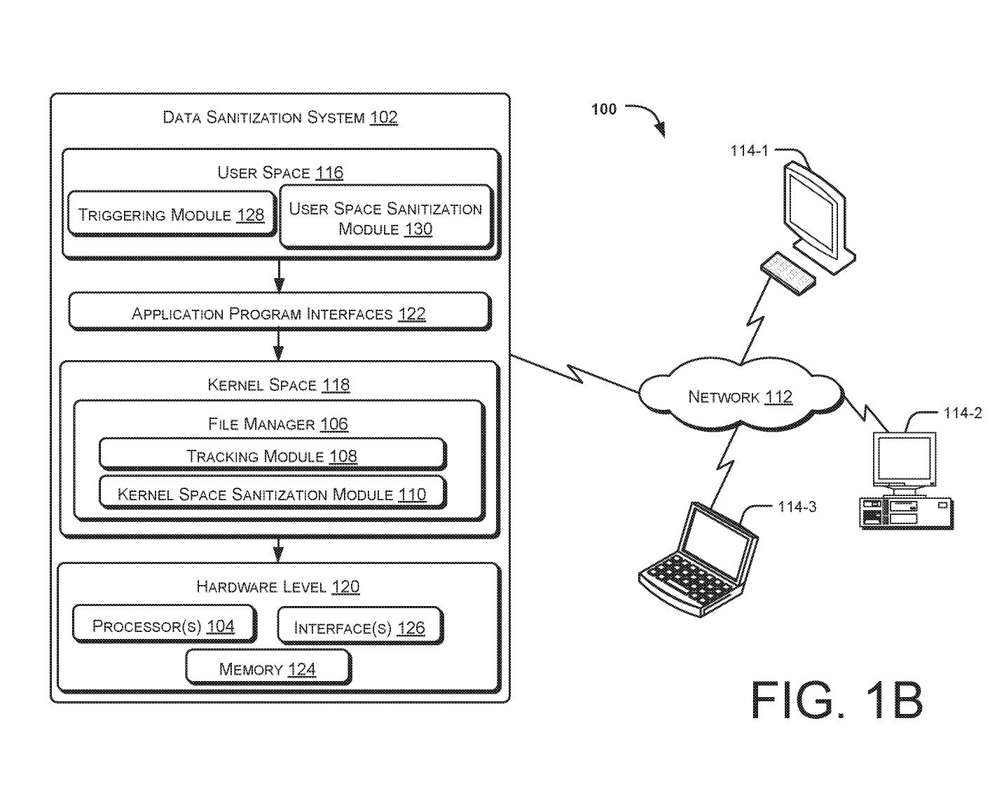

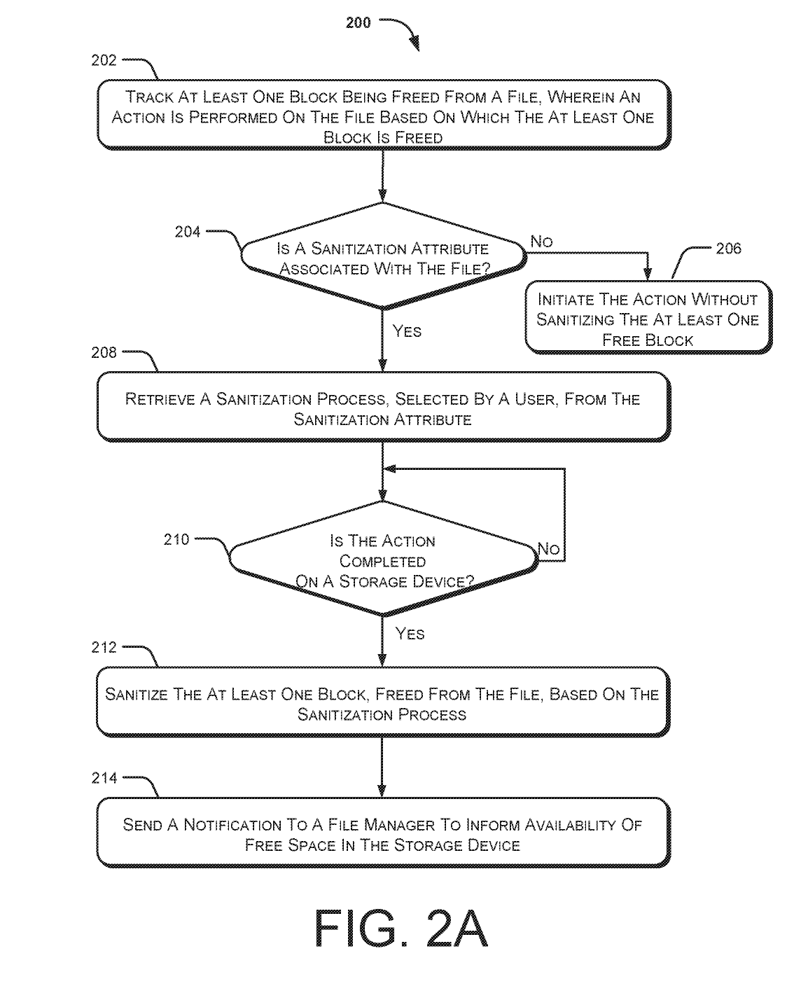

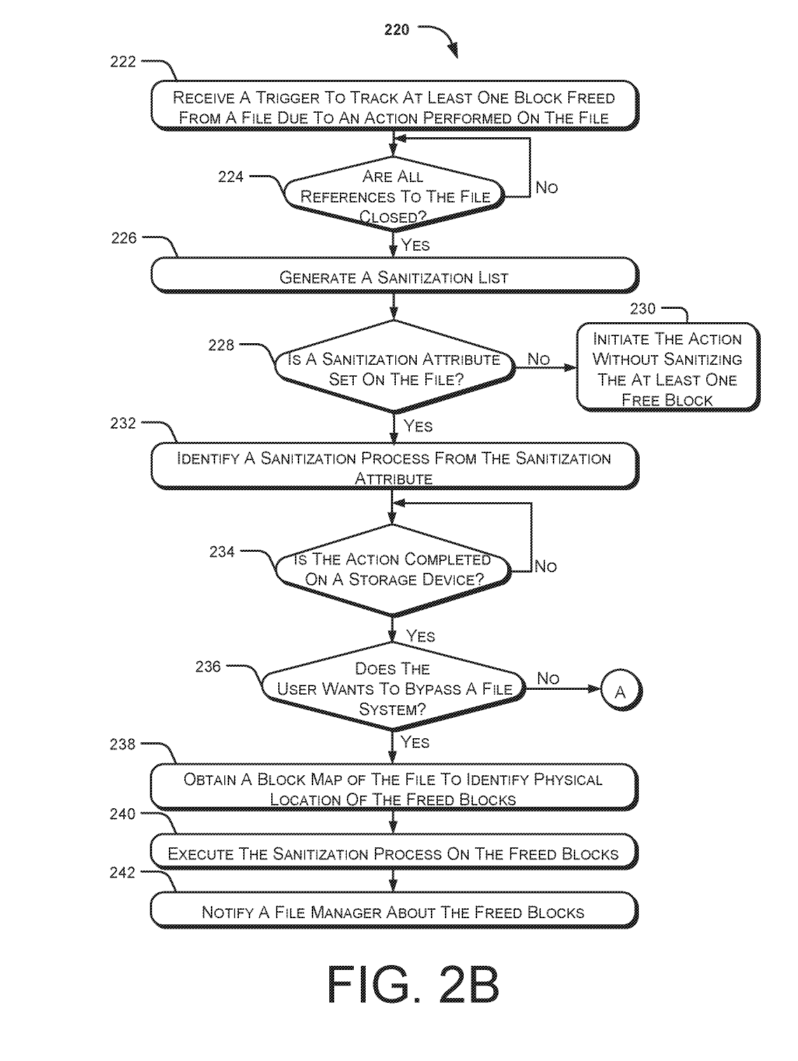

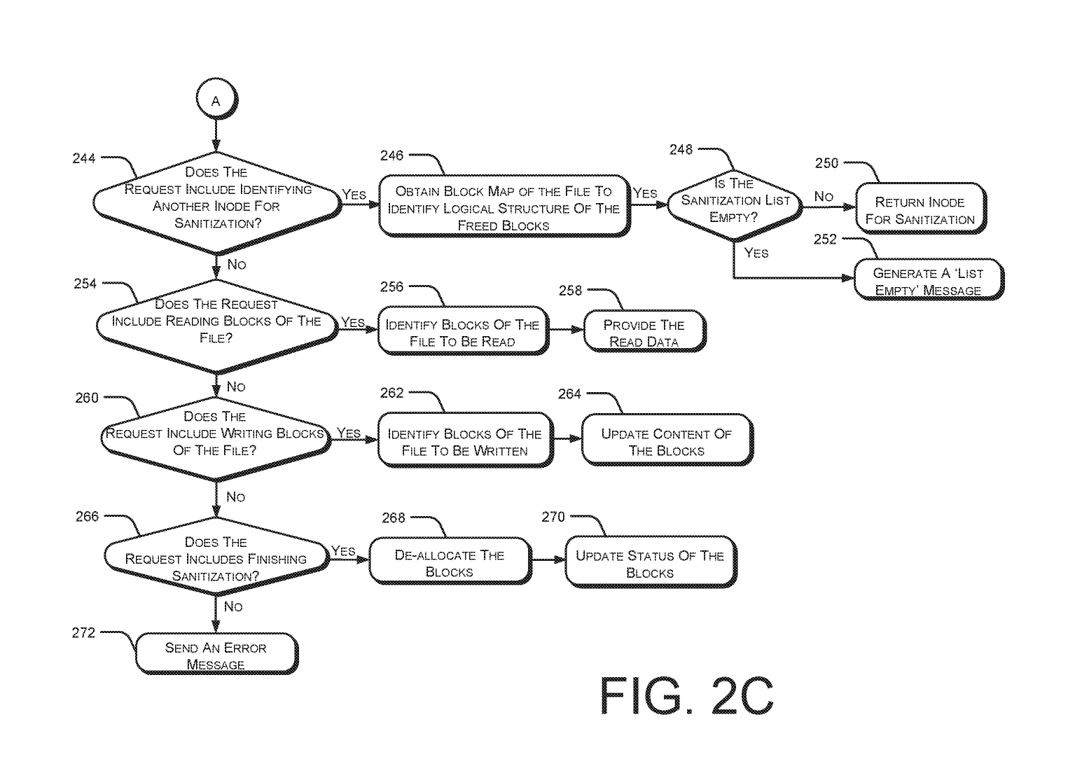

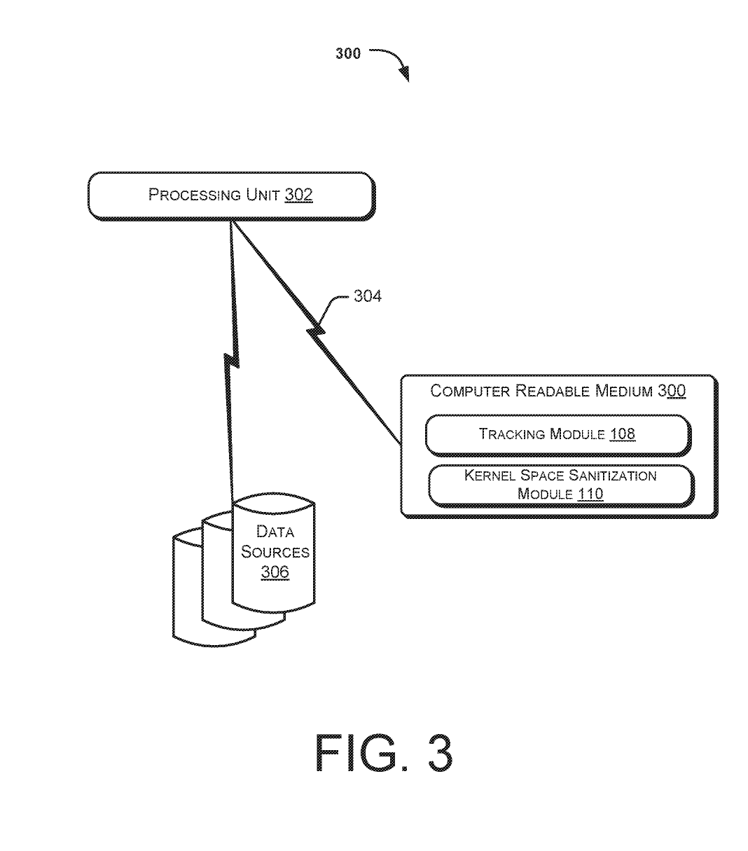

The manner in which the systems and the methods for sanitizing data are implemented are explained in details with respect to FIG. 1A, FIG. 1B, FIG. 2A, FIG. 2B, FIG. 2C, and FIG. 3. While aspects of described systems and methods for sanitizing data can be implemented in any number of different computing systems, environments, and/or implementations, the examples and implementations are described in the context of the following system(s).

FIG. 1A illustrates the components of a data sanitization system 102, according to an example of the present subject matter. In one example, the data sanitization system 102 may be implemented as any computing system, such as a desktop, a laptop, a mailing server, and the like. In another example, the data sanitization system 102 can be implemented in any network environment comprising a variety of network devices, including routers, bridges, servers, computing devices, storage devices, etc.

In one implementation, the data sanitization system 102 includes a processor 104 and a file manager 106 communicatively coupled to the processor 104. In some examples, the file manager 106 may include processor executable instructions to perform particular tasks, objects, components, data structures, functionalities, etc., to implement particular abstract data types, or a combination thereof. In some examples, the file manager 106 may be implemented as signal processor(s), state machine(s), logic circuitries, and/or any other device or component that manipulates signals based on operational instructions. Further, the file manager 106 can be implemented by hardware, by computer-readable instructions stored on a computer-readable medium and executable by a processing unit, or by a combination thereof. In one implementation, the file manager 106 includes a tracking module 108 and a kernel space sanitization module 110.

In one example, the tracking module 108 is coupled to the processor 104. The tracking module 108 receives a trigger when an action is performed on a file as a result of which the at least one block is freed. As may be understood, the file may be stored in a storage device of the data sanitization system 102 as a plurality of blocks of data. Further, the action may be one of a file deletion, file truncation, and file migration. Based on the trigger, the tracking module 108 determines whether all references to the file are closed or not. In case of a multi-tenant environment, if a user is accessing the file, the tracking module 108 may wait until the file is closed by all users. Once, the file is closed by all users, the tracking module 108 may track the at least one block being freed from the file. The tracking module 108 further generates a sanitization list that includes a list of inodes of the files that are either deleted or modified. The inodes in turn may track blocks that are freed from the file.

Further, the kernel space sanitization module 110 identifies if a sanitization attribute is associated with the file or not. The sanitization attribute indicates that when any block gets freed from the file, the freed blocks have to be sanitized. The sanitization attribute may include a descriptor. The descriptor may indicate a sanitization process that may be selected by the user. In an implementation, the sanitization process may be selected from a plurality of pre-defined sanitization processes. In another implementation, the sanitization process may be provided by the user. If no sanitization attribute is associated with the file, the kernel space sanitization module 110 may initiate a normal file removal process. On the other hand, if the sanitization attribute is associated with the file, the kernel space sanitization module 110 may identify the sanitization process to be used from the sanitization attribute.

Thereafter, the kernel space sanitization module 110 may determine whether the action is completed on the file or not. For example, in case of a file removal action, the kernel space sanitization module 110 determines whether or not the file removal action is committed to the storage device of the data sanitization system 102. Upon completion of the action, the kernel space sanitization module 110 may receive an inode from the sanitization list for executing the sanitization process. The operation of the data sanitization system 102 is described in greater detail in conjunction with FIG. 1B.

FIG. 1B illustrates a network environment 100 including the data sanitization system 102 according to another example of the present subject matter. The data sanitization system 102 may be implemented in various computing systems, such as personal computers, servers, and network servers. The data sanitization system 102 may be implemented on a stand-alone computing system or a network interfaced computing system. For example, for the purpose of providing cloud based data sanitization in the network environment 100, the data sanitization system 102 can be communicatively coupled over a network 112 with a plurality of computing devices 114-1, 114-2, . . . , 114-N. The computing devices 114-1, 114-2, . . . , 114-N, can be collectively referred to as computing devices 114, and individually referred to as a computing device 114, hereinafter. The computing devices 114 can include, but are not restricted to, desktop computers, laptops, smart phones, personal digital assistants (PDAs), tablets, and the like. The computing devices 114 are communicatively coupled to the data sanitization system 102 over the network 112.

In an implementation, the data sanitization system 102 may include a user space 116, a kernel space 118, and a hardware level 120. The user space 116 may be understood as a space which is used by the user to run applications. The kernel space 118 is reserved for running the kernel. The kernel is a piece of software responsible for providing secure access to the hardware level 120 for various programs in the user space 116. The kernel space 118 and the user space 116 may communicate with each other using application programming interfaces (APIs) 122. The APIs 122 may be provided as a user space library that any sanitization process can link with.

In an implementation, the hardware level 120 of the data sanitization system 102 includes the processor 104, and a memory 124 connected to the processor 104. The memory 124, communicatively coupled to the processor 104, can include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one example, the hardware components in the hardware level 120 may also have software associated with them though not explicitly mentioned herein.

The hardware level 120 of the data sanitization system 102 also includes interface(s) 126. The interfaces 126 may include a variety of interfaces, for example, interfaces for user device(s), storage devices, and network devices. The user device(s) may include data input and output devices, referred to as I/O devices. The interface(s) 126 facilitate the communication of the data sanitization system 102 with various communication and computing devices and various communication networks, such as networks that use a variety of protocols, for example, Hypertext Transfer Protocol (HTTP) and Transmission Control Protocol/Internet Protocol (TCP/IP).

Further, the data sanitization system 102 may include modules. In said implementation, the modules include a triggering module 128, a user-space sanitization module 130, the tracking module 108, the kernel-space sanitization module 110, and other module(s) (not shown in figure). The other module(s) may include programs or coded instructions that supplement applications or functions performed by the data sanitization system 102. The modules may be implemented as described in relation to FIGS. 1A and 1B.

In an implementation, the triggering module 128 provides a trigger to the user to set a sanitization attribute, such as a SecErase attribute, with at least one file stored in a storage device of the data sanitization system 102. The storage device may be a part of the memory 124 and can include an internal storage device, such as a hard disk of the data sanitization system 102, or an external storage device that is associated with the data sanitization system 102. Further, the sanitization attribute indicates that when any block gets freed from that file, the block is to be sanitized before being reused. Further, the sanitization attribute may be associated with a file by a user, such as by using the computing device 114. For enabling the user to associate the sanitization attribute, the triggering module 128 may provide a list of files stored in the data sanitization system 102 to the user. The user may select the at least one file with which the user may wish to associate the sanitization attribute. Alternatively, the sanitization attribute may be associated automatically with a file based on pre-defined rules, for example, when a data retention period for the file elapses.

In an implementation, the data sanitization system 102 may allow the user to strike a balance between sanitization and normal FS operations. The data sanitization system 102 facilitates the user to control bandwidth consumption for sanitization and normal FS operations. In this respect, the triggering module 128 may allow the user to pre-define consumption of resources, like the processor 104 and the memory 124. For example, the user may pre-define that during situations where sanitization and normal FS operations, like tiering, are taking place simultaneously, priority is to be given to the normal FS operations and the sanitization of blocks may be deferred for a later period of time, such as when there is less work load on the processor.

Further, the data sanitization system 102 enables the user to plug-in any sanitization process of choice, for sanitizing the freed blocks from a file. In this respect, the triggering module 128 generates a prompt for the user to select the sanitization process, when the user associates the sanitization attribute with the file. The sanitization process is indicated in the sanitization attribute as a descriptor. In an implementation, the user may select the sanitization process from a plurality of pre-defined sanitization processes stored in the data sanitization system 102. In another implementation, the plurality of pre-defined sanitization processes may be provided by a third party vendor. In yet another implementation, the user may provide a new sanitization process in the data sanitization system 102 for being selectable by the sanitization attribute. The users may select the sanitization process by means of the APIs 122. The APIs 122 communicate with the file system of the data sanitization system 102 using various input/output controls (IOCTLs).

During normal operation, when an action is performed on the at least one file, the triggering module 128 may generate a trigger indicating that an action is being performed on the at least one file. The action may result in at least one block of the file being freed. In an example, the at least one block may get freed due to a user initiated action on the file, such as deletion of the file, and truncation of the file. In another example, the block may get freed from a file due to automatic rule-based operations of the file system like tiering and defragmentation. In another example, the block may get freed from the file due to legal requirements of deleting a file having sensitive information after its retention period lapses.

The trigger generated by the triggering module 128 of the user space 116 may be received by the tracking module 108 of the file manager 106. The tracking module 108, upon receiving the trigger, may determine whether all references to the at least one file are closed or not. In case of a multi-tenant environment, if any user is still accessing the at least one file on which the action is performed, the tracking module 108 may wait till all references to the at least one file are closed. The tracking module 108 may further generate a sanitization list that includes one of an inode or a pseudo-inode of the files on which the action is performed.

In an implementation, if the action is that of a file is removal or deletion, the tracking module 108 may include an inode of the file in the sanitization list. The inode may include relevant information about the blocks of the removed file. In case of a sparse file, the inodes track specifically those blocks that were allocated to the sparse file. In another implementation, if the file is truncated or migrated, the tracking module 108 may create a pseudo-inode for being included in the sanitization list. The pseudo-inodes include information pertaining to those blocks that are truncated or migrated.

In an implementation, the data sanitization system 102 employs a journaling file system (FS). As may be understood, a journaling FS keeps track of various actions being performed in the FS. For this, the tracking module 108 maintains a log, also referred to as a journal, of all actions that are going to be performed by the file system. In an implementation, an action may include a sequence of steps and the journaling FS treats the sequence of steps as a single operation. For example, when a user transfers a file from one location to another location of the storage device, the kernel space sanitization module 110 may sanitize the freed blocks from the earlier location, when all steps involved in the transferring action are recorded on the log indicating that the action is complete. Actions that get tracked in the log may include any FS metadata update, for example, allocation of storage, de-allocation of storage, creation of a directory, deletion of a directory, and the like.

In an example, the generation of the sanitization list and tracking of the freed blocks is done irrespective of whether the sanitization attribute is associated with the file or not. Once the sanitization list is generated, the kernel space sanitization module 110 identifies whether or not the sanitization attribute is associated with each of the freed blocks. If no sanitization attribute is associated with the file, the kernel space sanitization module 110 may initiate a normal file removal process. The normal file removal process may be understood as marking the freed blocks of the file as free for reuse without sanitizing the blocks. In case the sanitization attribute is associated with the file, as mentioned above, the freed blocks have to be sanitized before reusing the freed blocks. To sanitize the freed blocks, the kernel space sanitization module 110 may identify the sanitization process from the sanitization attribute.

The kernel space sanitization module 110 may also determine whether the action is completed on the file or not. For example, in case of a file removal action, the kernel space sanitization module 110 determines whether or not the file removal action is committed to a storage device of the data sanitization system 102. If the action is not committed to the storage device, the kernel space sanitization module 110 waits for the action to get completed. As mentioned above, the tracking module 108 of the data sanitization system 102 maintains the log in the memory 124 until the action is completed. Once the action is completed, the user space sanitization module 130 receives the inode of the file. In an example, the user space sanitization module 130 receives the inode through the APIs 122. The user space sanitization module 130 may invoke secdel_get_next_inode API to receive the inode of the file on which the sanitization process is to be performed. Once the user space sanitization module 130 receives the inode from the sanitization list, the kernel space sanitization module 110 removes the inode from the sanitization list to avoid sanitizing of the same inode twice.

In an implementation, during any action on the file, such as a file removal action, if the data sanitization system 102 crashes, during system recovery process after system reboot, the kernel space sanitization module 110 may communicate with the tracking module 108 to retrieve the log from the memory 124. The kernel space sanitization module 110 may determine whether all steps pertaining to the file removal action were completed before the data sanitization system 102 crashed. In this respect, the kernel space sanitization module 110 may check if the latest entry in the log relates to completion of the file removal action. If the latest entry indicates completion of the action, the kernel space sanitization module 110 proceeds with sanitizing the freed blocks. In case the latest entry does not indicate completion of the file removal action, i.e., all the steps related to the file removal action are not completed, the kernel space sanitization module 110 may roll back the previous steps to undo the action. In such cases, a user may have to repeat initiation of the action on the file. Thus, using the log prevents any loss in data due to system crash and also reduces recovery time after the system crash.

Upon retrieving the inode for removal, the kernel space sanitization module 110 determines whether, to proceed with the sanitization, the user would bypass the FS of the data sanitization system 102 or not. The kernel space sanitization module 110 may interact with the user space sanitization module 130 to determine whether the user would like to bypass the FS of the data sanitization system 102. In an implementation, if the user intends to bypass the FS and directly use an IO stack for sanitization, the sanitization module 110 retrieves a block map of the file in a buffer. To do so, the user space sanitization module 130 may interact with a secdel_get_blkmap API of the APIs 122. The block map may include a physical location of the freed blocks. In an implementation, if the user intends to use the FS for issuing sanitization IOs, the user space sanitization module 130 may interact with the secdel_get_blkmap API of the APIs 122 to retrieve a logical structure of the file.

Accordingly, the kernel space sanitization module 110 may execute the sanitization process, as indicated in the sanitization attribute, on the freed blocks. In an example, the sanitization process may perform read/write functions on the block map. The sanitization process selected by the user may include at least one pass. Once the sanitization process is completely executed on the freed blocks, the kernel space sanitization module 110 may inform the file manager 106 that the sanitization is completed on the freed blocks and the freed blocks may now be reused. To do so, the user space sanitization module 130 may invoke secdel_close_inode API from the APIs 122.

Thus, the data sanitization system 102 enables the users to selectively sanitize freed blocks of a file instead of having to sanitize an entire storage device. The data sanitization system 102 allows the user to plug-in any sanitization process to sanitize the freed blocks. Further, the data sanitization system 102 employs a journaling FS for maintaining a log of various steps involved in an action. The log helps in reducing recovery time after a crash. Also, in case of a crash, if the action on the file is not completed, the log may be retrieved from the memory 124 to check for the latest entry in the log. Based on the latest entry, the data sanitization system 102 may either roll back or roll forward some steps of the action. Accordingly, the log helps in completion of the sanitization process in an efficient manner without loss of data. Furthermore, the data sanitization system 102 facilitates the users to control bandwidth consumption when sanitization and other file system operations are occurring simultaneously.

FIGS. 2A, 2B, and 2C illustrate methods 200 and 220 for sanitizing data, according to an example of the present subject matter. The order in which the methods 200 and 220 are described is not intended to be construed as a limitation, and some of the described method blocks can be combined in a different order to implement the methods 200 and 220, or an alternative method. Additionally, individual blocks may be deleted from the methods 200 and 220 without departing from the spirit and scope of the subject matter described herein. Furthermore, the methods 200 and 220 may be implemented in any suitable hardware, computer-readable instructions, or combination thereof.

The steps of the methods 200 and 220 may be performed by either a computing device under the instruction of machine executable instructions stored on a computer readable medium or by dedicated hardware circuits, microcontrollers, or logic circuits. Herein, some examples are also intended to cover computer readable medium, for example, digital data storage media, which are machine or computer readable and encode machine-executable or computer-executable instructions, where said instructions perform some or all of the steps of the described methods 200 and 220.

With reference to method 200 as depicted in FIG. 2A, at block 202 the method 200 includes tracking at least one block being freed from a file when an action, such as deletion, migration, and truncation, is performed on the file based on which the at least one block is freed. In an implementation, the tracking module 108 may receive a trigger to track the at least one block when the action is performed on the file. Further, the tracking module 108 generates a sanitization list that includes a list of inodes of the files that are either deleted or modified. The inodes in turn may track the blocks that are freed from the file.

As depicted in block 204, the method 200 includes identifying whether a sanitization attribute is associated with the file or not. In an implementation, the kernel space sanitization module 110 checks for the sanitization attribute. If the sanitization attribute is not associated with the file, the method 200 moves to block 206 and if the sanitization attribute is associated with the file, the method 200 moves to block 208.

As shown in block 206, if the sanitization attribute is not associated with the file, the action is performed on the at least one freed block without sanitization.

As illustrated in block 208, the method 200 may include retrieving a sanitization process, selected by a user, from the sanitization attribute. In an implementation, the kernel space sanitization module 110 may retrieve the sanitization process from the sanitization attribute. The sanitization process may be selected from a list of pre-defined sanitization processes or may be provided by the user.

Further, at block 210, the method 200 may include determining whether the action is completed on a storage device or not. In an implementation, the sanitization module 110 may check a log maintained in the memory 124 of the data sanitization system 102. If the latest entry of the log indicates that the action is not completed, the kernel space sanitization module 110 will wait for the completion of the action. Once, it is determined by the kernel space sanitization module 110 that the action is completed, the method 200 proceeds to block 212. For example, if the action is that of a file removal, the kernel space sanitization module 110 may check whether the file removal action is committed to the log on the storage device or not.

At block 212, the method 200 includes sanitizing the at least one block, based on the sanitization process indicated by the sanitization attribute. In an implementation, the user space sanitization module 130 executes the sanitization process on the at least one block, freed from the file.

At block 214, the method 200 may include sending a notification to a file manager 106 of the data sanitization system 102 to inform availability of free space in the storage device. The user space sanitization module 130 may send a notification to the file manager 106 to reuse the sanitized blocks.

With reference to FIGS. 2B & 2C, at block 222, the method 220 includes receiving a trigger to track at least one block freed from a file due to an action performed on the file. In an implementation, a user may use the triggering module 128 to perform the action on the file. The action may be one of a file removal, file truncation, file migration, and the like. Further, the tracking module 108 may receive the trigger from the triggering module 128.

As shown in block 224, upon receiving the trigger, it is checked, whether all references to the file are closed or not. In an implementation, the tracking module 108 may check if any user is still accessing the file. If the file is being used by any user, the tracking module 108 waits for the user to close the file. Once the file is not being referred by any user, the method 220 moves to block 226.

As depicted in block 226, a sanitization list may be generated that includes a list of inodes of the files that are either deleted or modified. The inodes in turn may track the blocks that are freed from the file. In an example, the tracking module 108 generates the sanitization list.

As illustrated in block 228, it is identified whether a sanitization attribute is set on the file or not. In an implementation, the kernel space sanitization module 110 identifies if the file is associated with the sanitization attribute. In case, the file is not associated with the sanitization attribute, the method 220 moves to block 230 and if the sanitization attribute is associated with the file, the method 220 moves to block 232.

At block 230, if the sanitization attribute is not associated with the file, the action is performed on the at least one freed block without sanitization. The kernel space sanitization module 110 performs the action on the file.

As illustrated in block 232, the method 220 may include retrieving a sanitization process, selected by a user, from the sanitization attribute. In an implementation, the sanitization attribute includes a descriptor indicative of the sanitization process selected by the user, for sanitizing the freed blocks. The kernel space sanitization module 110 may retrieve the sanitization process from the sanitization attribute. The sanitization process may be selected from a list of pre-defined sanitization processes or may be provided by the user.

Further, at block 234, the method 220 may include determining whether the action is completed on a storage device or not. In an implementation, the kernel space sanitization module 110 may check a log maintained in a file system of the data sanitization system 102. If the latest entry of the log indicates that the action is not completed, the kernel space sanitization module 110 will wait for the completion of the action. Once, it is determined by the kernel space sanitization module 110 that the action is completed, the method 220 proceeds to block 236.

As depicted in block 236, it is determined whether the user wants to bypass the FS for sanitizing the freed blocks. The kernel space sanitization module 110 determines whether or not the user intends to bypass the FS. If the user intends to bypass the FS, the method 220 moves to block 238.

As shown in block 238, a block map of the file is obtained. In an implementation, the kernel space sanitization module 110 obtains the block map of the file to identify a physical location of the freed blocks.

At block 240, the sanitization process is executed on the freed blocks. For example, the kernel space sanitization module 110 may execute the sanitization process on the freed blocks.

Further, at block 242, a notification is sent to a file manager 106 of the data sanitization system 102 to inform availability of free space in the storage device. The kernel space sanitization module 110 may send a notification to the file manager 106 to reuse the sanitized blocks.

Referring back to block 236, if the user intends to use the FS for sanitizing the freed blocks, the method 220 moves to block 244. The FS may receive a request from the file manager 106. At block 244, it is determined whether the request is for identifying a new inode for sanitization. If the kernel space sanitization module 110 determines that the request pertains to identifying another inode for sanitization, the method 200 moves to block 246.

At block 246, the block map of the file is obtained. In an implementation, the kernel space sanitization module 110 obtains an inode from the sanitization list. Thereafter, the kernel space sanitization module 110 obtains the block map of the file to identify a logical structure of the freed blocks.

As shown in block 248, it is determined whether the sanitization list is empty or not. The kernel space sanitization module 110 determines whether the sanitization list includes another inode for sanitization or not.

In case the sanitization list includes another inode for sanitization, the kernel space sanitization module 110 may select the inode for sanitization, as shown in block 250. On the other hand, if the sanitization list is empty, a ‘list empty’ notification is generated by the kernel space sanitization module 110, as illustrated in block 252.

Referring again to block 244, if the request is not for identifying another inode for sanitization, the method 220 moves to block 254. At block 254, it is determined if the request is for reading the blocks of the file. The kernel space sanitization module 110 may determine the request by communicating with the APIs 122.

At block 256, if a secdel_read_blocks request is received, the blocks, to be read, of the file are identified by the user space sanitization module 130. In an implementation, the user needs to specify the logical structure of the file. Upon identification, the user space sanitization module 130 may issue read instructions on those blocks. Based on the read instructions, the user space sanitization module 130 may provide the read content to the data sanitization system 102, as depicted in block 258.

Further, at block 254, if the request is not for reading the blocks of the file, the method 220 moves to block 260. At block 260, it is determined, by the sanitization module, if the request is for writing on the blocks of the file. The user space sanitization module 130 may determine the request by communicating with the APIs 122.

At block 262 if a secdel_write_blocks request is received, the blocks, to be written, of the file are identified by the user space sanitization module 130. In an implementation, the user needs to specify the logical structure of the file. Upon identification, the user space sanitization module 130 may issue write instructions on those blocks. Based on the write instructions, the sanitization module 130 may inform the user about the updated content of the blocks, as depicted in block 264.

Further, at block 260, if the request is not for writing on the blocks of the file, the method 220 moves to block 266. At block 266, it is determined if the request indicates that sanitization is performed on the blocks.

As shown in block 268, if a secdel_close_inode request is received, the user space sanitization module 130 may de-allocate the sanitized blocks. Thereafter, at block 270, the kernel space sanitization module 110 may update status of the blocks in the file manager 106.

At block 266, if the request does not indicate completion of the sanitization process, the method 220 moves to block 272. In an implementation, the kernel space sanitization module 110 generates an error message to indicate that the request is not correct.

FIG. 3 illustrates a computer readable medium 300 storing instructions for data sanitization, according to an example of the present subject matter. In one example, the computer readable medium 300 is communicatively coupled to a processing unit 302 over a communication link 304.

For example, the processing unit 302 can be a computing customer device, such as a server, a laptop, a desktop, a mobile customer device, and the like. The computer readable medium 300 can be, for example, an internal memory customer device or an external memory customer device, or any non-transitory computer readable medium. In one implementation, the communication link 304 may be a direct communication link, such as any memory read/write interface. In another implementation, the communication link 304 may be an indirect communication link, such as a network interface. In such a case, the processing unit 302 can access the computer readable medium 300 through a network.

The processing unit 302 and the computer readable medium 300 may also be communicatively coupled to data sources 306 over the network. The data sources 306 can include, for example, databases and computing customer devices. The data sources 306 may be used by the requesters and the agents to communicate with the processing unit 302.

In one implementation, the computer readable medium 300 includes a set of computer readable instructions, such as the tracking module 108 and the kernel space sanitization module 110. The set of computer readable instructions can be accessed by the processing unit 302 through the communication link 304 and subsequently executed to perform acts for sanitizing data.

On execution by the processing unit 302, the tracking module 108 may track at least one block being freed from a file. The at least one block is freed from the file, when an action, such as deletion, truncation, and migration, is performed on the file. The tracking module 108 may receive a trigger, from a triggering module 128, to track the at least one freed block. The kernel space sanitization module 110 may thereafter determine whether a sanitization attribute is associated with the file or not. In case the sanitization attribute is associated, the kernel space sanitization module 110 may retrieve a sanitization process from the sanitization attribute. The sanitization process may be selected by the user from a list of pre-defined sanitization processes or may be provided by the user. Based on the sanitization process, the kernel space sanitization module 110 may, upon completion of the action on a storage device, execute the sanitization process on the freed blocks to sanitize the freed blocks.

Although implementations for data sanitization have been described in language specific to structural features and/or methods, it is to be understood that the appended claims are not necessarily limited to the specific features or methods described. Rather, the specific features and methods are disclosed as examples of systems and methods for sanitizing data.

I/We claim:

1. A method for sanitizing data stored within a storage device of a data sanitization system, the method comprising:
tracking, by a processor, removal of data from at least one block of a file, wherein an action is performed on the file to remove the data;
identifying, by the processor, whether a sanitization attribute is associated with the file, wherein the sanitization attribute includes a descriptor indicating a sanitization process selected by a user,
based on the identification, determining, by the processor, whether the action is completely performed on the file; and
based on the determination, sanitizing, by the processor, the at least one block based on the sanitization process indicated in the sanitization attribute.

2. The method as claimed in claim 1 further comprising marking, by the processor, the sanitized blocks as free for de-allocation.

3. The method as claimed in claim 1, wherein the tracking comprises receiving a trigger to track physical location of at least one block being freed from the file.

4. The method as claimed in claim 1, wherein the action is one of a deletion, truncation, migration, and defragmentation.

5. The method as claimed in claim 3, wherein the trigger is activated by one of a user and a pre-defined rule.

6. The method as claimed in claim 1, wherein the determining comprises maintaining a log of a plurality of steps involved in the action performed on the file.

7. The method as claimed in claim 6 further comprising determining, by the processor, if the data sanitization system has crashed during the action.

8. The method as claimed in claim 7 further comprising:
determining, by the processor, if a latest entry in the log indicates a status of the action, wherein the status is one of complete and incomplete; and
upon determination, conducting, by the processor, one of a roll back and a roll forward on steps performed for the action before the data sanitization system crashed.

9. A data sanitization system for sanitizing data stored within a storage device of the data sanitization system, wherein the data sanitization system comprises:
a processor; and
a file manager comprising,
a tracking module, coupled to the processor, to
receive a trigger when an action is performed on the file as a result of which the at least one block is freed;
determine whether all references to the file are closed; and
track the at least one block and generate a sanitization list containing inode of the file, based on the determination, wherein the inode tracks blocks that are freed from the file; and
a kernel space sanitization module, coupled to the processor, to
identify if a sanitization attribute is associated with the file, wherein the sanitization attribute includes a descriptor indicating a sanitization process selected by a user; and
execute the sanitization process on the sanitization list based on a block map, based on the identification.

10. The data sanitization system as claimed in claim 9, wherein the tracking module further maintains a log of a plurality of steps involved in the action performed on the file.

11. The data sanitization system as claimed in claim 9, wherein the kernel space sanitization module determines whether the user intends to bypass a file system and obtains the block map of the file.

12. The data sanitization system as claimed in claim 11, wherein the block map is one of a logical structure and a physical location of the file.

13. The data sanitization system as claimed in claim 9, wherein the sanitization process is selected from one of a set of pre-defined sanitization processes and a user-defined sanitization process.

14. The data sanitization system as claimed in claim 9, wherein the kernel space sanitization module identifies whether the action is completed on the file.

15. A non-transitory computer-readable medium having a set of computer readable instructions that, when executed, cause a data sanitization system to:
receive a trigger to track at least one block being freed from the file, wherein an action is performed on the file as a result of which the at least one block is freed;
identify whether a sanitization attribute is associated with the file, wherein the sanitization attribute includes a descriptor indicating a sanitization process selected by a user;
determine whether the action is completely performed on the file, based on the identification;
sanitize the at least one block based on the sanitization process indicated in the sanitization attribute; and
mark sanitized blocks as free for de-allocation.
